(19) United States
(12) Patent Application Publication
(10) Pub. No.: US 2024/0184964 A1
(43) Pub. Date: Jun. 6, 2024

(54) PARAMETER CALIBRATION FOR SIMULATION OF A TRANSISTOR DESIGN

(71) Applicant: Synopsys, Inc., Sunnyvale, CA (US)

(72) Inventors: Jingtian FANG, San Jose, CA (US); Oleg PENZIN, Cameron Park, CA (US); Shela J. ABOUD, San Francisco, CA (US); Dipanjan BASU, St. Portland, OR (US)

(21) Appl. No.: 18/515,017

(22) Filed: Nov. 20, 2023

Related U.S. Application Data
(60) Provisional application No. 63/429,571, filed on Dec. 2, 2022.

(51) Int. Cl. G06F 30/3308

(52) U.S. Cl. CPC G06F 30/3308; G06F 2113/18

(57) ABSTRACT

A system and method generates a model for a transistor design and simulates a transistor design using the model. A two-dimensional model of a transistor design is obtained. A density-gradient model for a channel of the transistor design is determined based on the two-dimensional model to generate a first set of parameters. A long-channel mobility model for the channel of the transistor design is determined based on the two-dimensional model to generate a second set of parameters. Further, a ballistic model and high-field saturation model of the transistor design are determined based on the first set of parameters and the second set of parameters to generate a third set of parameters. The third set of parameters are output to a memory device.

### RELATED APPLICATION

This application claims the benefit of U.S. provisional patent application Ser. No. 63/429,571, filed Dec. 2, 2022, which is hereby incorporated herein by reference.

### TECHNICAL FIELD

The present disclosure relates to determining parameters for a transistor design using models, and simulating the transistor design based on the parameters.

### BACKGROUND

As circuits have become more complex, electronic design automation software tools have been developed to facilitate designing, testing and modifying circuit designs in preparation for manufacturing (i.e., fabricating or otherwise producing) physical integrated circuit (IC) devices. The IC devices are manufactured based on final versions of the circuit designs. Because modern IC devices (e.g., System-on-Chip devices, among others) can include many transistors and other circuit elements, electronic design automation tools have become essential in the development and testing of modern circuit designs, including design of specific chip components such as transistors.

### SUMMARY

In one example, a method includes obtaining a two-dimensional model of a transistor design, and determining, by a processor, a density-gradient model for a channel of the transistor design based on the two-dimensional model to generate a first set of parameters. The method further includes determining, by the processor, a long-channel mobility model for the channel of the transistor design based on the two-dimensional model to generate a second set of parameters. Further, the method includes determining, by the processor, a ballistic model and high-field saturation model of the transistor design based on the first set of parameters and the second set of parameters to generate third set of parameters. The method further includes outputting the third set of parameters to a memory device.

In one example, a system includes a memory storing instructions, and a processor. The processor is coupled with the memory and executes the instructions. The instructions when executed cause the processor to obtain a two-dimensional model of a transistor design, and determine a density-gradient model for a channel of the transistor design based on the two-dimensional model to generate a first set of parameters. The processor is further caused to determine a long-channel mobility model for the channel of the transistor design based on the two-dimensional model to generate a second set of parameters. Further, the processor is caused to determine a ballistic model and high-field saturation model of the transistor design based on the first set of parameters and the second set of parameters to generate third set of parameters. The processor is further caused to output the third set of parameters to the memory.

In one example, a non-transitory computer readable medium includes stored instructions. The stored instructions, when executed by a processor, cause the processor to generate a first set of parameters for a transistor design based on a density-gradient model for a channel of the transistor design. Further, the processor is caused to generate a second set of parameters for the transistor design based on a long-channel mobility model for the channel of the transistor design. The processor is further caused to generate a third set of parameters for the transistor design based on a ballistic model and high-field saturation model of the transistor design, the first set of parameters, and the second set of parameters. Further, the processor is caused to simulate the transistor design based on the third set of parameters.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates an exemplary Gate-All-Around Field Effect Transistor (GAAFET) in accordance with some embodiments of the present disclosure.

FIG. 2 illustrates a schematic block diagram of a circuit design system in accordance with some embodiments of the present disclosure.

FIG. 3 illustrates a flowchart of a method for generating parameters of a transistor design in accordance with some embodiments of the present disclosure.

FIG. 4 illustrates a flowchart of a method for generating first set of parameters of a transistor design in accordance with some embodiments of the present disclosure.

FIG. 5 illustrates a graph of results of generating parameters in accordance with some embodiments of the present disclosure.

FIG. 6 illustrates a flowchart of a method for generating second set of parameters of a transistor design in accordance with some embodiments of the present disclosure.

FIGS. 7A, 7B, and 8 illustrate graphs of results of generating parameters in accordance with some embodiments of the present disclosure.

FIGS. 9A, 9B, and 9C illustrate graphs of results of applying using the generated parameters to simulate a transistor design in accordance with some embodiments of the present disclosure.

FIGS. 10A and 10B illustrate tables showing reduction in computation resources using the present disclosure.

FIG. 11 depicts a diagram of an example computer system in which embodiments of the present disclosure may operate.

### DETAILED DESCRIPTION

Aspects of the present disclosure relate to parameter calibration for simulation of a transistor design. Design Technology Co-Optimization (DTCO) is a methodology that is used within the semiconductor manufacturing process to reduce costs and time-to-market in advanced process development. DTCO solutions, such as those described herein, enable the efficient evaluation and down-selection of new transistor architectures, materials and other process options using power, performance, area and cost (PPAC) design metrics. By deploying DTCO, technology development teams evaluate and optimize new transistor architectures with Technology Computer Aided Design (TCAD) processes.

Advanced circuit technologies employ gate-all-around field-effect transistors (GAAFETs). GAAFETs have lower power requirements and an increased performance at a reduced circuit area and manufacturing cost as compared to other transistor technologies. The channel materials of a GAAFET include Silicon, Silicon-Germanium, or Germanium nanosheets. In other examples, other materials may be used for the channel. The channel material is surrounded by dielectric oxide materials, which can show a quantum confinement effect and ballistic transport effect at the dimensions of a typical GAAFET (e.g., sub-40 nm gate length, height of sub-10 nm, and a width of sub-30 nm).

The quantum confinement effects and ballistic transport effects can be calculated or simulated using physics-sophisticated TCAD processes and/or other design and simulation processes (band structure engine and advanced carrier transport engine) including band structure calculation and carrier transport simulation by solving Schrodinger equation. However, these design and simulation processes are computationally intensive, having a long turn-around-time and using a large amount of processing resources, increasing the manufacture cost of developing a corresponding semiconductor device. In one or more examples, large transistor structures can require at least 200 hours of computing time for a simulation. Due to the long runtime and large amount of processing resources being required, the use of such physics-sophisticated TCAD processes is limited in the manufacturing of semiconductor devices.

The present disclosure discloses a circuit design process that uses physical models in a simpler and analytic form and simulates carrier transport across a GAAFET channel by solving drift-diffusion equations, using less processing time and processing resources. Further, the circuit design process described calibrates physical model parameters that allow for a decreased design turn-around-time with an improved accuracy and quality of simulated results as that compared to other simulation processes without calibration. Further, the circuit design process described herein uses a calibration flow to evaluate the performance of transistors with regard to different channel dimensions. The circuit design process described herein provides a methodology for calibration of the physical model parameters, such that GAAFET designs of varying dimensions can be simulated in an efficient manner, thus improving the speed of semiconductor design and manufacturing process, while also maintaining accuracy of simulation.

The circuit design process discussed herein numerically simulates the electrical behavior of a single semiconductor device in isolation, or several physical devices combined in a circuit. Terminal currents, voltages, and charges are computed based on a set of physical device factors that describes the carrier distribution and conduction mechanisms. A semiconductor device, such as a transistor, is represented during the simulation process as a ‘virtual’ device. The semiconductor device has physical properties that are discretized onto a non-uniform ‘grid’ (or ‘mesh’) of nodes.

The circuit design process described herein uses a virtual device that is an approximation of a real device. Continuous properties such as doping profiles are represented on a sparse mesh and, therefore, are only defined at a finite number of discrete points in space. The doping at any point between nodes (or any physical quantity calculated by the Device software tool) can be obtained by interpolation. Each virtual device structure includes at least the following information of a grid (or geometry) of the virtual device containing a description of the various regions (e.g., boundaries, material types, and/or the locations of electrical contacts, among others). Further, the grid contains the locations of all the discrete nodes and the corresponding connectivity. Additionally, or alternatively, the virtual device structure includes properties of the device (e.g., the doping profiles in the form of data associated with the discrete nodes). In one example, a device simulated in two dimensions (2D) is assumed to have a ‘thickness’ in the third dimension of 1 micrometer.

In one or more examples, the circuit design process described here includes a set of models for device physics and effects in semiconductor devices. The set of models includes drift diffusion, thermodynamic, and/or hydrodynamic models, among others. The circuit design process may additionally, or alternatively, include support for different device geometries (1D, 2D, 3D, and/or 2D cylindrical, among others). Further, the circuit design process additionally, or alternatively includes mixed-mode support of electrothermal netlists with mesh-based device models and SPICE (Simulation Program with Integrated Circuit Emphasis) circuit models.

The circuit design process of the present disclosure is described in reference to the simulation of GAAFETs. The simulation of the GAAFET before manufacturing aids in more efficient semiconductor chip design, as the design can be perfected for one or more parameters before manufacture. While the present disclosure describes design of GAAFETs, similar techniques can be applied to the design of other types of transistors.

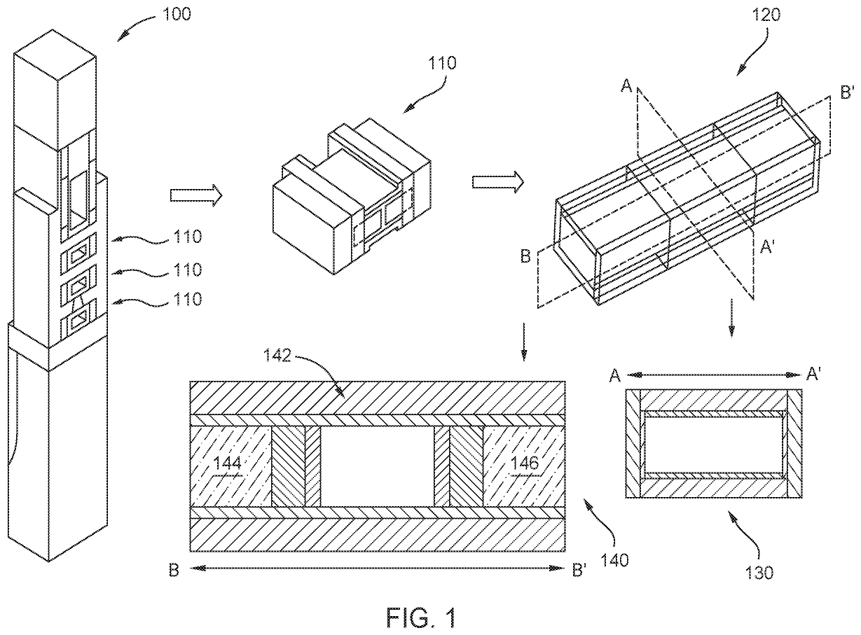

FIG. 1 illustrates an exemplary three-channel GAAFET 100 to which the presently disclosed circuit design process can be applied. The GAAFET of exemplary FIG. 1 includes one or more gates.

The GAAFET 100 includes nanosheet FETs 110. FIG. 1 illustrates a close up depiction of the nanosheet FETs 110 that is part of the GAAFET 100. Each of the nanosheet FETs 110 includes a channel 120. FIG. 1 is a close-up of a single channel 120 of GAAFET 100. The channel 120 is made of silicon, silicon-germanium, or germanium, among others. The channel 120 has a length in a range of about 5 nm to about 100 nm. In other examples, the length may be less than about 5 nm or greater than about 100 nm. FIG. 1 further includes a cross-section 130 along plane A-A′ of the channel 120. Further, FIG. 1 includes a side view 140 of channel 120. The side view 140 is along the plane B-B′ of the channel 120. As is illustrated by the side view channel 140, a nanosheet FET 110 includes gate 142, source 144 and drain 146.

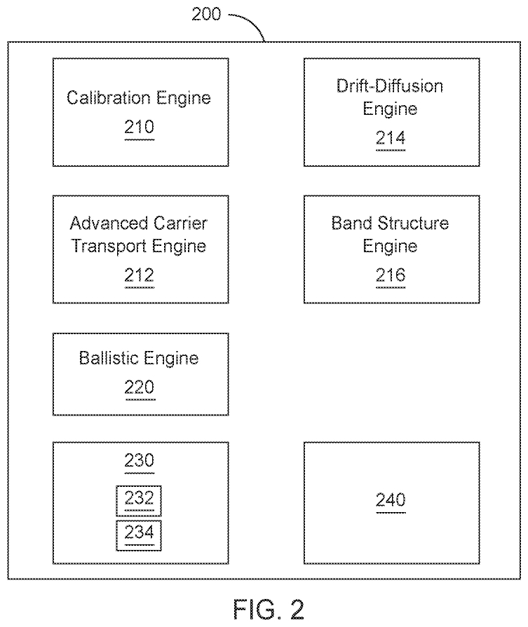

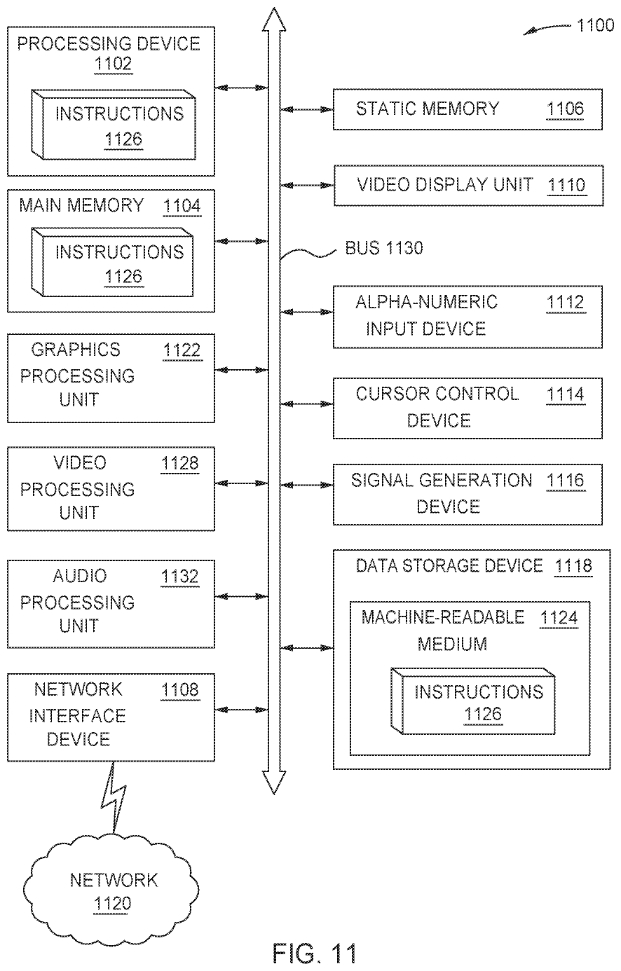

FIG. 2 illustrates a block diagram of a circuit design system 200, according to one or more examples. The circuit design system 200 is TCAD tool or an electronic design automation (EDA) tool. The circuit design system 200 includes one or more processing devices (e.g., processing devices 1102 of FIG. 11), that executes instructions (e.g., instructions 1126 of FIG. 11) stored in a memory (e.g., the memory 230, main memory 1104 of FIG. 11 and/or the machine-readable storage medium 1124 of FIG. 11) to perform the calibration processes circuit design simulation processes as described in the following.

As illustrated in FIG. 2, the circuit design system 200 includes a calibration engine 210, an advanced carrier transport engine 212, a drift-diffusion engine 214, a band structure engine 216, a ballistic engine 220, and a memory 230.

The calibration engine 210 includes one or more processing devices (e.g., processing devices 1102 of FIG. 11) that execute instructions (e.g., instructions 1126 of FIG. 11) stored in a memory (e.g., the memory 230, main memory 1104 of FIG. 11 and/or the machine-readable storage medium 1124 of FIG. 11) to perform the functions as described in the following in the calibration of the transistor design 232.

The advanced carrier transport engine 212 includes one or more processing devices (e.g., processing devices 1102 of FIG. 11) that execute instructions (e.g., instructions 1126 of FIG. 11) stored in a memory (e.g., the memory 230, main memory 1104 of FIG. 11 and/or the machine-readable storage medium 1124 of FIG. 11) to perform the functions as described in the following in the calibration of a transistor design 232.

The drift-diffusion engine 214 includes one or more processing devices (e.g., processing devices 1102 of FIG. 11) that execute instructions (e.g., instructions 1126 of FIG. 11) stored in a memory (e.g., the memory 230, main memory 1104 of FIG. 11 and/or the machine-readable storage medium 1124 of FIG. 11) to perform the functions as described in the following in the calibration of a transistor design 232.

The band structure engine 216 includes one or more processing devices (e.g., processing devices 1102 of FIG. 11) that execute instructions (e.g., instructions 1126 of FIG. 11) stored in a memory (e.g., the memory 230, main memory 1104 of FIG. 11 and/or the machine-readable storage medium 1124 of FIG. 11) to perform the functions as described in the following in the calibration of a transistor design 232.

The ballistic engine 220 includes one or more processors (e.g., processing devices 1102 of FIG. 11) that execute instructions (e.g., instructions 1126 of FIG. 11) stored in a memory (e.g., the memory 230, main memory 1104 of FIG. 11 and/or the machine-readable storage medium 1124 of FIG. 11) to determine model parameters by calibrating a ballistic model and a high-field saturation model, as is described in the following.

The memory 230 may be configured similar to that of the main memory 1104 of FIG. 11 and/or the machine-readable storage medium 1124 of FIG. 11. The memory 230 includes the transistor design 232.

In one or more examples, the circuit design system 200 includes a graphical user interface (GUI) 240. The GUI 240 displays the output of the calibration process and/or simulation process as described in the following. For example, the GUI 240 displays the determined parameters and/or the output of simulating the transistor design 232. The GUI 240 is displayed within a display device (e.g., the video display unit 1110). In one example, the GUI 240 allows for a user to interact with the output via a user interface device (e.g., the alphanumeric input device 1112 and/or the cursor control device 1114 of FIG. 11).

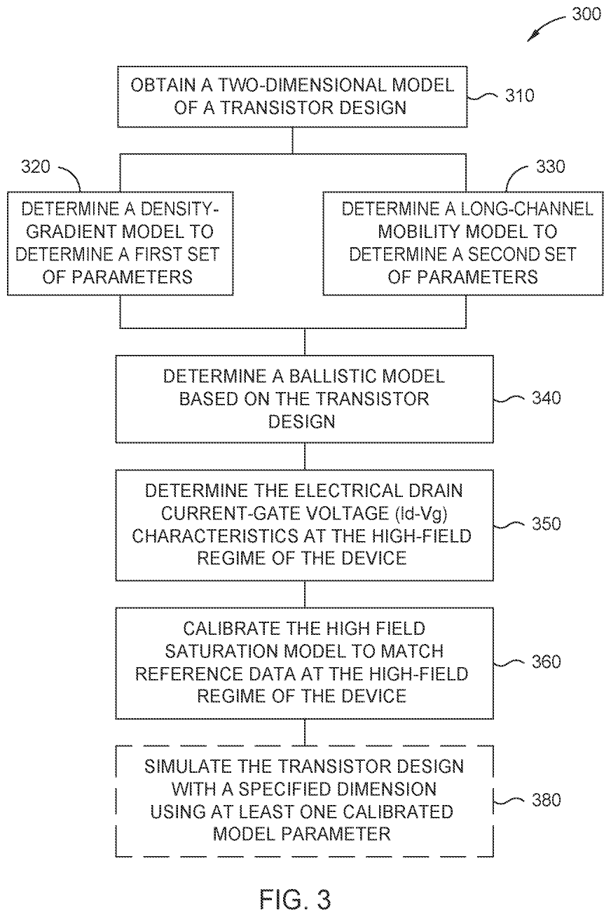

FIG. 3 illustrates a flowchart of a method 300 for determining parameters of a transistor of a circuit design, according to one or more examples. The method 300 is performed by the circuit design system 200 of FIG. 2. For example, one or more processors of the circuit design system 200 execute instructions stored within a memory to perform the method 300.

At 310, a two-dimensional model of a transistor design is obtained. For example, the calibration engine 210 of FIG. 1 obtains (e.g., receives) a two-dimensional model of a transistor design 232 from the memory 230, another engine within the circuit design system 200, or a system external to and connected to the circuit design system 200.

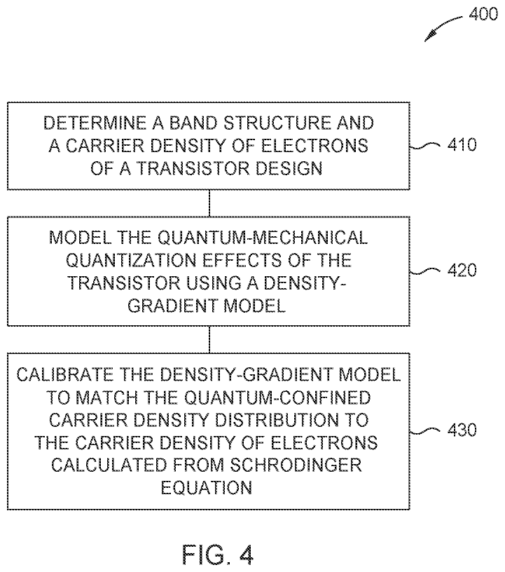

At 320, a density-gradient model is determined from the two-dimensional model to determine the first set of parameters. In one example, the calibration engine 210 determines the density-gradient model from the two-dimensional model. In one example, the density-gradient model is used to determine first set of parameters. In one example, determining the density-gradient model includes calibrating the density-gradient model based on the two-dimensional model as shown in the flowchart of method 400 in FIG. 4.

At 410 of the method 400, a band structure and a carrier density of electrons of the transistor cross-section are determined. In one example, the band structure and the carrier density of the electrons in a cross-section of a quantum-confined channel of the transistor design 232 are determined by solving Schrödinger's equation in the band structure engine 216. The band structure and the carrier density of the electrons are stored in the memory 230.

At 420, the quantum-mechanical quantization effects of the transistor are modeled using a density-gradient model. In one example, the quantum-mechanical quantization effects of the transistor are modeled in the drift-diffusion engine using a density-gradient model as specified in the following as described by Equation 1. The potential-like quantity, Λₙ, is introduced into the density formula for electrons to include quantization effects, as represented by equation 1.

$$n = {N}_{c} {F}_{1 / 2} ( \frac{{E}_{F , n} - {E}_{c} - {Λ}_{n}}{k {T}_{n}} ) \qquad Equation 1$$

In equation 1, N_{C} is the electron effective density of states, E_{F,n} represents electron quasi-Fermi energies, E_{C} is a conduction band edge, k is a Boltzmann constant, and Tₙ is the electron temperature. For the density-gradient model employed here, Λₙ is given by a partial differential equation, as shown in equation 2. In equation 2, γ is a fitting factor.

$${Λ}_{n} = - \frac{γ {ℏ}^{2}}{12 {m}_{n}} \{ {∇}^{2} ln n + \frac{1}{2} {( ∇ ln n )}^{2} \} = - \frac{γ {ℏ}^{2}}{6 {m}_{n}} \frac{{∇}^{2} \sqrt{n}}{\sqrt{n}} \qquad Equation 2$$

In one example, modeling the quantum-mechanical quantization effects of the transistor using a density-gradient model generates a quantum-confined carrier density distribution. The quantum-confined carrier density distribution is stored within the memory 230.

At 430, the density-gradient model is calibrated. For example, the calibration engine 210 calibrates the density-gradient model to match the quantum-confined carrier density distribution generated at 420 to the carrier density of electrons generated at 410. The density-gradient model is calibrated at various gate bias (Vg) conditions. Calibrating the density gradient model determines the first set of parameters. For example, the density gradient model is calibrated to determine the parameters γ and mₙ in equation 2. The first set of parameters are output and stored within the memory 230.

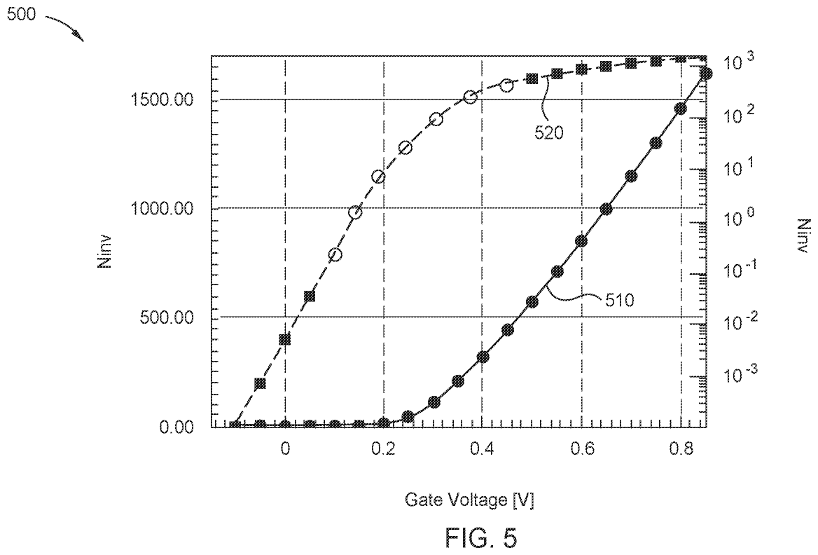

FIG. 5 illustrates the graph 500 illustrate the results of calibrating the density-gradient model. In FIG. 5, the curve 510 representing the total carrier density of the cross-section in linear scale (shown on the left Y-axis), Ninv, is calibrated to match the total carrier density from 410 and stored in the memory 230 (e.g., shown in the FIG. 5 by the solid circle marker). The curve 520 represents the same data in log scale on the right Y-axis, illustrating close fit at small gate voltage range.

With further reference to FIG. 3, at 330, a long-channel mobility model of a transistor design is used to determine second set of parameters. In one example, the band structure engine 216 determines the long-channel mobility model at the channel cross-section of a transistor design to determine the second set of parameters. In one example, the source and drain mobilities are determined at a biased non-equilibrium state for the transistor design using the advanced carrier transport engine 212. The source and drain mobilities are determined (e.g., calculated) at a biased non-equilibrium state using moments of an inverse scattering operator. Further, in one or more examples, the source and drain mobilities are imported to a constant mobility model in drift-diffusion engine 214. The constant mobility model is specified for the source and drain regions, respectively. For an example cross-section of 5 nm×5 nm, a mobility of 32 cm²/(V·s) is extracted for both the source and drain regions.

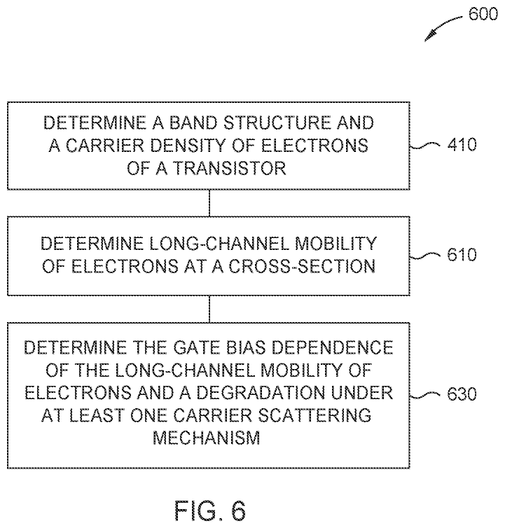

FIG. 6 illustrates a flowchart of the method 600 for determining the long-channel mobilities. At 410, a band structure and a carrier density of electrons of the transistor cross-section are determined as is described in greater detail in the above.

At 610, the long-channel mobility of electrons is determined at the channel cross-section. In one example, the long-channel mobility of electrons is determined based on the band structure and sub-band electronic wave functions at the cross-section 130 using the band structure engine 216. The long-channel mobility of electrons is stored within the memory 230. In one example, the long-channel mobility is determined based on electron-phonon scattering. In one or more examples, the mobility calculated at zero gate bias can be imported to the constant mobility model in the drift-diffusion engine 214. The constant mobility model is specified for the particular channel region. In one example, the mobility calculated at zero gate bias is the maximum mobility of the channel of the GAAFET without taking into account mobility degradations due to surface phonon scattering, surface roughness scattering, and/or electric field effect. For the given cross-section of 5 nm×5 nm of this exemplary use case, a mobility of 357 cm²/(V·s) is extracted from the model.

At 630, the gate bias dependence of the long-channel mobility of electrons as degradation under at least one carrier scattering mechanisms is determined. In one example, the calibration engine 210 determines the gate bias dependence of the long-channel mobility of electrons as degradation under at least one carrier scattering mechanisms. In one example, the gate bias dependence is the electric field dependence. In one or more examples, the long-channel mobility of electrons is determined for a surface phonon scattering and surface roughness scattering. For example, the long-channel mobility of electrons is determined for one or more of the scattering mechanisms of electron-phonon scattering, surface roughness scattering, and Coulomb scattering, among others.

In one or more examples, the calibration engine 210 selects an enhanced Lombardi model in the drift-diffusion engine 214 to use in the determined carrier mobility degradation due to phonon scattering and surface roughness scattering, respectively. The surface contribution due to acoustic phonon scattering can be represented by equation 3.

$${μ}_{a c} = \frac{B}{{F}_{⊥}} + \frac{C {( \frac{{N}_{A , 0} + {N}_{D , 0} + {N}_{2}}{{N}_{0}} )}^{λ}}{{{F}_{⊥}^{\frac{1}{3}} ( \frac{T}{300 K} )}^{k}} \qquad Equation 3$$

In equation 3, F₁₉₅ the transverse electric field normal to the semiconductor-insulator interface, B and C are model parameters, T is the temperature, N_{A,0} and N_{D,0} are acceptor and donor concentration. In one example, N₂=1, N₀=1, and λ is 0.125 for electron and is 0.0317 for hole.

The contribution attributed to surface roughness scattering is given by equation 4.

$${μ}_{sr} = {( \frac{{( \frac{{F}_{⊥}}{{F}_{ref}} )}^{A *}}{δ} + \frac{{F}_{⊥}^{3}}{η} )}^{- 1} \qquad Equation 4$$

In equation 4, A*=2, F_{ref}=1 V/cm, η=5.82×10³⁰V²/(cm·s) for electrons and η=2.0546×10³⁰ V²/(cm·s) for holes. The parameter δ is the model parameter that can be calibrated using the techniques disclosed herein. The parameters B, C, and & are determined as the second set of parameters and output (e.g., stored) within the memory 230.

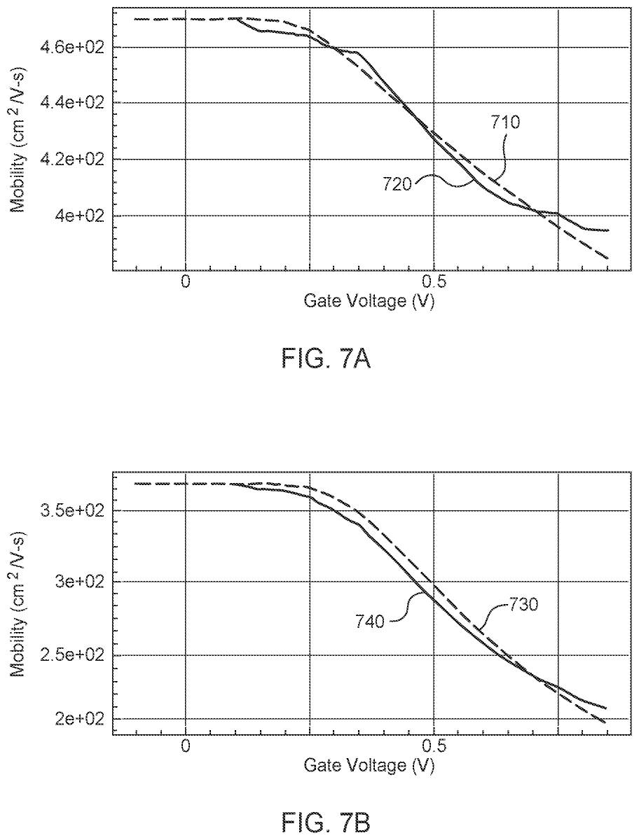

In one example, the mobility degradation due to surface phonon scattering can be calibrated to the reference mobility data that is generated based on phonon scattering. Such a calibration is performed based on a large surface roughness scattering in the enhanced Lombardi model by the calibration engine 210. FIG. 7A illustrates can example of such a calibration with corresponding parameters. As can be seen in FIG. 7A, the mobility is mapped as a function of the gate voltage. As the gate voltage increases, the mobility decreases. Further, by performing the calibration process as described above, the curve 710 representing the determined mobility per gate voltage in the drift-diffusion engine 214 is adjusted to be more aligned with the curve 720 representing the determined reference mobility per gate voltage from band structure engine 216.

In one or more examples, the mobility degradation of electrons due to both surface phonon scattering and surface roughness scattering in the enhanced Lombardi model are considered and calibrated to match the reference mobility data generated when both phonon scattering and surface roughness scattering are considered. FIG. 7B illustrates such a calibration and parameters. Curve 730 of FIG. 7B represents the determined mobility per gate voltage after calibration and curve 740 of FIG. 7B represents the reference mobility data. As can be seen, after calibration, differences between the curves 730 and 740 are mitigated.

At 340, a ballistic model is determined based on the transistor design. In one example, the ballistic engine 220 determines the ballistic model. In one or more examples, determining the ballistic model includes calibrating the ballistic model. In one or more examples, calibrating the ballistic model is based on a three-dimensional model of the transistor design 232. The ballistic effect is determined using a channel length-dependent ballistic mobility model during the calibration. An example channel length-dependent ballistic mobility model can be represented by equation 5.

μ_{bal}=k·L_{ch} Equation 5

In equation 5, k is the ballistic model parameter and L_{ch} is a user-defined parameter which is specified as the gate lengths for the transistor design 232. The parameters k and L_{ch} are stored within the memory 230.

In one or more examples, the ballistic mobility model is calibrated based on the calibration parameters determined at 320 (e.g., first set of parameters), the calibration parameters determined at 330 (e.g., second set of parameters), and electrical drain current-gate voltage (Id-Vg) of the transistor design 232. For example, the ballistic engine 220 obtains the first and second set of parameters from the memory 230 to use the first and second set of parameters during the calibration process of the ballistic model. In one example, the Id-Vg characteristics of the transistor design 232 are determined at the linear operation regime of the device. The Id-Vg characteristics are determined based on a three-dimensional model of the transistor design 232. In one example, the drain-source voltage is biased to a voltage of Vdₗᵢₙ=0.05V. However, other voltage biases may be used in other embodiments. In one or more examples, for a gate length of 15 nm on the GAAFET, the carrier may undergo ballistic transport from source to drain, without an occurrence of a scattering event.

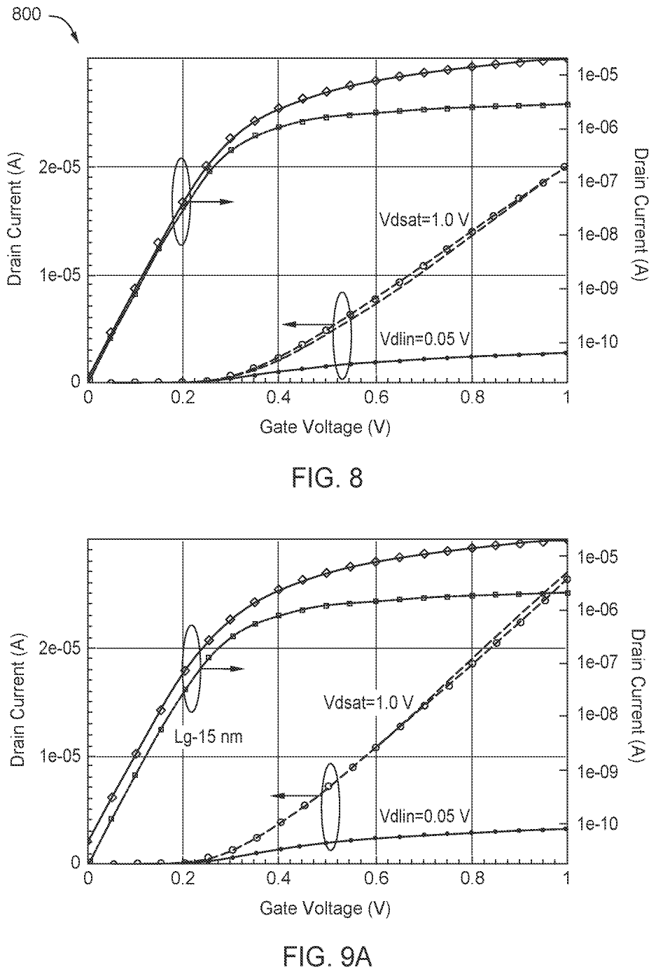

In one or more examples, the ballistic mobility model is calibrated based on the Id-Vg reference data by applying one or more calibrated model parameters determined at 320 and/or 330. In one or more examples, surface roughness scattering model parameter(s) in the enhanced Lombardi model are included together when calibrating the ballistic mobility model to account for the short channel length in real device Id-Vg simulations, which is different from the long channel length used in long-channel mobility calculations. The results for a GAAFET with a channel length of 30 nm is illustrated in graph 800 of FIG. 8. As shown in FIG. 8, the curves representing the output from each of the software tools are almost exactly aligned with one another after calibration.

At 350, the device electrical drain current-gate voltage (Id-Vg) characteristics at the saturation regime of the device is determined. The advanced carrier transport engine 212 calculates the device electrical drain current-gate voltage (Id-Vg) characteristics at the saturation regime of the device. In one example, the device electrical drain current-gate voltage (Id-Vg) characteristics at the saturation regime of the device are determined based on a drain-source voltage. In one or more examples, the drain-source voltages is Vdₛₐₜ=1.0 V. In other embodiments, other values of Vdₛₐₜ may be used.

In one or more examples, the advanced carrier transport engine 212 determines the fundamental and physical Boltzmann transport equation and intrinsically captures the high-field saturation of drift velocity, and the drift-diffusion engine 214 account for the carrier drift velocity saturation using the high-field saturation model. In one example, the Extended Canali Model can be used, which is represented by equation 6.

$$μ ( F ) = \frac{{μ}_{l o w}}{{[ 1 + {( \frac{{μ}_{l o w} {F}_{hfs}}{{v}_{sat}} )}^{β} ]}^{1 / β}} \qquad Equation 6$$

In equation 6, μ_{low} denotes the low-field mobility, which comes from the mobility considered at previous step(s) of method 300. β is a unitless exponent, vₛₐₜ is the saturation velocity, and the parameter F_{hfs} is the electric field. One or more of the scattering mechanisms of electron-phonon scattering, surface roughness scattering, and Coulomb scattering may be considered at 350.

At 360, the high field saturation model is further calibrated to match reference data at the saturation regime of the device. The calibration engine 210 calibrates the high field saturation model, such that the Id-Vg data generated from drift-diffusion engine 214 matches the Id-Vg reference data from the advanced carrier transport engine 212 at a value of Vdₛₐₜ. In one example, the first set of parameters is applied to the density gradient model and the second set of parameters is applied to the enhanced Lombardi model. Further, the high field saturation model is also tuned. The calibration of 350 and 360 mitigate the differences between the Id-Vg curves generated by the processes. The calibration generates values for the ballistic mobility model parameter k, the enhanced Lombardi model surface roughness model parameter δ, and the high field saturation model parameters, β and vₛₐₜ.

In one example, the final optimized parameters, for one exemplary use case, of the ballistic mobility model parameter k, the enhanced Lombardi model surface roughness model parameter δ, the high field saturation model parameters, β and vₛₐₜ, are listed in table 1.

TABLE 1

| k | 14.25 | cm²/(V · s · nm) |
|---|---|---|
| δ | 2.679e14 | cm²/(V · s) |
| β | 0.645 | |
| νₛₐₜ | 4.374e7 | cm/s |

At 380, at least one model parameter determined at 360 is optionally utilized to simulate a transistor design of a specified dimension. 380 is optionally performed, and in one or more examples, 380 is omitted from the method 300. In exemplary embodiments, any one or more of the parameters generated from method 300 are applied to simulate GAAFET designs of the same cross-section (e.g., 5 nm×5 nm), but at different gate lengths. For example, GAAFET gate lengths of 15 nm, 40 nm, and 100 nm may be simulated, covering a wide range of technology nodes. In one example, 380 includes receiving a second transistor design, and simulating the second transistor design at different gate lengths based on the at least one model parameter determined at 360. At 380, the model parameters for one transistor design can be used to simulate another transistor design at different gate lengths.

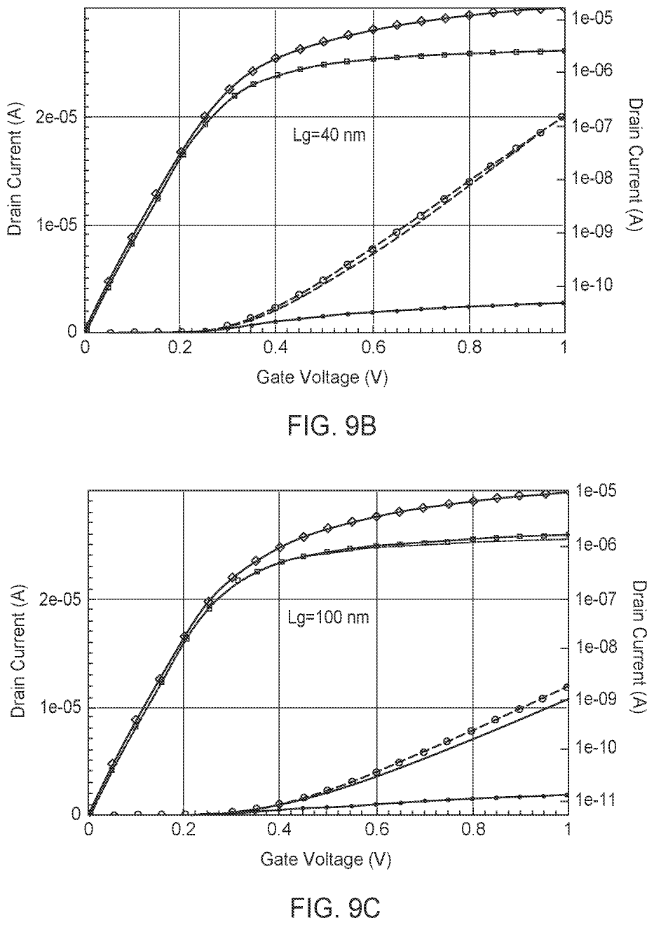

FIG. 9A depicts calibration results for a 15 nm gate length GAAFET, FIG. 9B depicts calibration results for a 40 nm gate length GAAFET, and FIG. 9C depicts calibration results for a 100 nm gate length GAAFET. As shown in FIGS. 9A, 9B, and 79C, the Id-Vg curves for all the gate lengths are in close match after calibration. This validation shows the transferability and predictability of the calibrated parameter(s) generated using method 300 of FIG. 3. Thus, calibrating the parameter(s) for one particular gate length yields model parameters that can also be applied to other gate lengths without having to re-calibrate every gate length individually. As such, the calibration methodology disclosed herein is reliable, and beneficial when exploring GAAFET designs with different cross-section geometries.

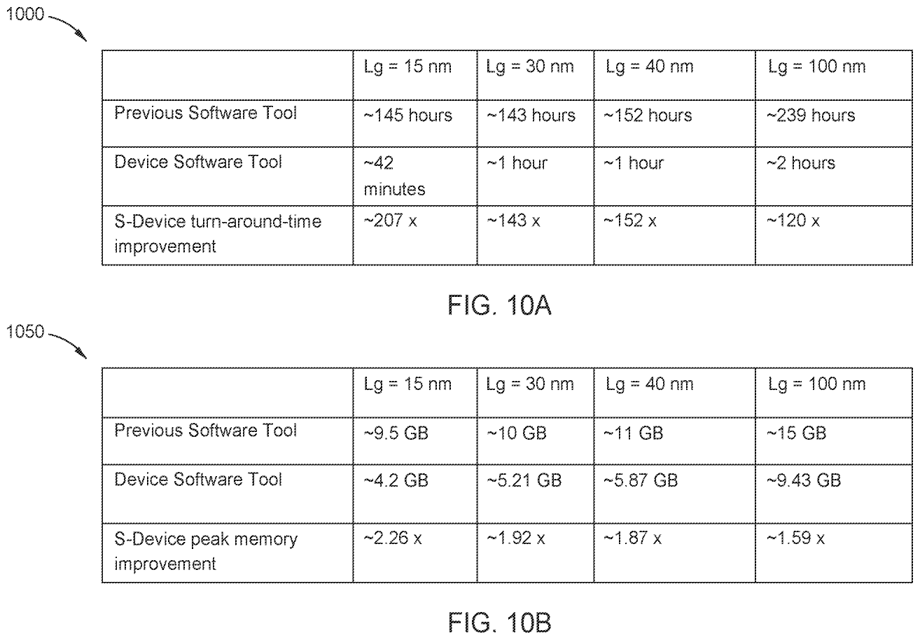

Further, the use of the processes to implement the disclosed methodology results in a significant savings of computing resource power and time. FIGS. 10A and 10B depict tables 1000 and 1050, respectively, comparing the total processing time needed when simulating the same cross-section (5 nm×5 nm) GAAFETs with different gate lengths of 15 nm, 30 nm, 40 nm and 100 nm. FIG. 10A shows that for a gate length of 15 nm, the CPU time needed for the simulation is reduced from approximately 145 hours to approximately 42 minutes. For a gate length of 100 nm, the processing time needed for the simulation is reduced from approximately 239 hours to approximately 2 hours.

FIG. 10B shows a comparison of the amount of peak memory utilized for the simulations. The table of FIG. 10B shows that for a gate length of 15 nm, the memory needed for the simulation is reduced from 9.5 GB to approximately 4.2 GB. For a gate length of 100 nm, the amount of CPU memory needed for the simulation is reduced from approximately 15 GB to approximately 9.43 GB.

As shown in FIGS. 10A and 10B, the turn-around processing time is reduced by more than 120 times. Thus, design flows can benefit greatly from this runtime improvement, as the processes as described in the above provide more efficient advanced transistor and IC device designs.

FIG. 11 illustrates an example machine of a computer system 1100 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1100 includes a processing device 1102, a main memory 1104 (e.g., read-only memory (ROM), flash memory, dynamic random access memory (DRAM) such as synchronous DRAM (SDRAM), a static memory 1106 (e.g., flash memory, static random access memory (SRAM), etc.), and a data storage device 1118, which communicate with each other via a bus 1130.

Processing device 1102 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1102 may also be one or more special-purpose processing devices such as an application specific integrated circuit (ASIC), a field programmable gate array (FPGA), a digital signal processor (DSP), network processor, or the like. The processing device 1102 may be configured to execute instructions 1126 for performing the operations and steps described herein.

The computer system 1100 may further include a network interface device 1108 to communicate over the network 1120. The computer system 1100 also may include a video display unit 1110 (e.g., a liquid crystal display (LCD) or a cathode ray tube (CRT)), an alphanumeric input device 1112 (e.g., a keyboard), a cursor control device 1114 (e.g., a mouse), a graphics processing unit 1122, a signal generation device 1116 (e.g., a speaker), graphics processing unit 1122, video processing unit 1128, and audio processing unit 1132.

The data storage device 1118 may include a machine-readable storage medium 1124 (also known as a non-transitory computer-readable medium) on which is stored one or more sets of instructions 1126 or software embodying any one or more of the methodologies or functions described herein. The instructions 1126 may also reside, completely or at least partially, within the main memory 1104 and/or within the processing device 1102 during execution thereof by the computer system 1100, the main memory 1104 and the processing device 1102 also constituting machine-readable storage media.

In some implementations, the instructions 1126 include instructions to implement functionality corresponding to the present disclosure. While the machine-readable storage medium 1124 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 1102 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method comprising:
obtaining a two-dimensional model of a transistor design;
determining, by a processor, a density-gradient model for a channel of the transistor design based on the two-dimensional model to generate a first set of parameters;
determining, by the processor, a long-channel mobility model for the channel of the transistor design based on the two-dimensional model to generate a second set of parameters;
determining, by the processor, a ballistic model and high-field saturation model of the transistor design based on the first set of parameters and the second set of parameters to generate a third set of parameters; and
outputting the third set of parameters to a memory device.

2. The method of claim 1, wherein the two-dimensional model of the transistor design comprises at least a channel height and width.

3. The method of claim 1, wherein the transistor design is of a gate all around field effect transistor.

4. The method of claim 1, wherein determining the density-gradient model for the channel of the transistor design comprises determining the density-gradient model of electron in a two-dimensional cross-section of the channel of the transistor design.

5. The method of claim 1 further comprising:
determining a degradation for the channel of the transistor design under at least one carrier scattering mechanism, wherein first set of parameters, the second set of parameters, third set of parameters are determined based on the degradation for the channel of the transistor design.

6. The method of claim 1 further comprising:
simulating the transistor design using at least one of the first set of parameters, the second set of parameters, or the third set of parameters.

7. The method of claim 1 further comprising:
simulating a second transistor design using at least one of the first set of parameters, the second set of parameters, or the third set of parameters.

8. A system comprising:
a memory storing instructions; and
a processor, coupled with the memory and to execute the instructions, the instructions when executed cause the processor to:
obtain a two-dimensional model of a transistor design;
determine a density-gradient model for a channel of the transistor design based on the two-dimensional model to generate a first set of parameters;
determine a long-channel mobility model for the channel of the transistor design based on the two-dimensional model to generate a second set of parameters;
determine a ballistic model and high-field saturation model of the transistor design based on the first set of parameters and the second set of parameters to generate a third set of parameters; and
output the third set of parameters to the memory.

9. The system of claim 8, wherein the two-dimensional model of the transistor design comprises at least a channel height and width.

10. The system of claim 8, wherein the transistor design is of a gate all around field effect transistor.

11. The system of claim 8, wherein determining the density-gradient model for the channel of the transistor design comprises determining the density-gradient model of electron in a two-dimensional cross-section of the channel of the transistor design.

12. The system of claim 8, wherein the processor is further caused to:
determine a degradation for the channel of the transistor design under at least one carrier scattering mechanism, wherein at least one of the first set of parameters, the second set of parameters, and the third set of parameters is determined based on the degradation for the channel of the transistor design.

13. The system of claim 8, wherein the processor is further caused to:
simulate the transistor design using at least one of the first set of parameters, the second set of parameters, or the third set of parameters.

14. The system of claim 8, wherein the processor is further caused to:
simulate a second transistor design using at least one of the first set of parameters, the second set of parameters, or the third set of parameters.

15. A non-transitory computer readable medium comprising stored instructions, which when executed by a processor, cause the processor to:
generate a first set of parameters for a transistor design based on a density-gradient model for a channel of the transistor design;
generate a second set of parameters for the transistor design based on a long-channel mobility model for the channel of the transistor design;
generate a third set of parameters for the transistor design based on a ballistic model and high-field saturation model of the transistor design, the first set of parameters, and the second set of parameters; and
simulate the transistor design based on the third set of parameters.

16. The non-transitory computer readable medium of claim 15, wherein the processor is further caused to determine the density-gradient model for the channel of the transistor design based on a two-dimensional model.

17. The non-transitory computer readable medium of claim 16, wherein the processor is further caused to determine the long-channel mobility model for the channel of the transistor design based on the two-dimensional model.

18. The non-transitory computer readable medium of claim 15, wherein the processor is further caused to:
determine a degradation for the channel of the transistor design under at least one carrier scattering mechanism, wherein at least one of the first set of parameters, the second set of parameters, and the third set of parameters is determined based on the degradation for the channel of the transistor design.

19. The non-transitory computer readable medium of claim 15, wherein the processor is further caused to:
simulate the transistor design using at least one of the first set of parameters, the second set of parameters, or the third set of parameters.

20. The non-transitory computer readable medium of claim 15, wherein the processor is further caused to:
simulate a second transistor design using at least one of the first set of parameters, the second set of parameters, or the third set of parameters.
